(19) United States
(12) Patent Application Publication
(10) Pub. No.: US 2023/0373452 A1
(43) Pub. Date: Nov. 23, 2023

(54) HYDRAULIC PRESSURE CONTROL UNIT

(71) Applicant: Robert Bosch GmbH, Stuttgart (DE)

(72) Inventor: Yuki Ikeda, Kanagawa (JP)

(21) Appl. No.: 18/260,262

(22) PCT Filed: Dec. 16, 2021
(86) PCT No.: PCT/IB2021/061815

§ 371 Date: Jul. 3, 2023

(30) Foreign Application Priority Data
Jan. 7, 2021 (JP) 2021-001172

(51) Int. Cl. B60T 13/66; B60T 13/68; B60T 8/32

(52) U.S. Cl. CPC B60T 13/662; B60T 13/686; B60T 8/3225

(57) ABSTRACT

The present invention obtains a hydraulic pressure control unit capable of accurately estimating a stroke amount of an armature of an electromagnetic valve.

The hydraulic pressure control unit according to the present invention includes an estimation section that estimates a stroke amount (Δx) of an armature (312) of an electromagnetic valve (31). The estimation section estimates a stroke amount (Δx) on the basis of a reduced amount of a current value at a time when the current value is temporarily reduced in a process that the current value of a current flowing through a wire (314) is increased toward a target current value at beginning of application of the current to the wire (314) of the electromagnetic valve (31).

### BACKGROUND

The present disclosure relates to a hydraulic pressure control unit capable of accurately estimating a stroke amount of an armature of an electromagnetic valve.

### BACKGROUND ART

Conventionally, as a behavior control system for controlling behavior of a vehicle such as a motorcycle, there is a system using a hydraulic pressure control unit that controls a hydraulic pressure generated in a hydraulic fluid. In the hydraulic pressure control unit, the hydraulic pressure generated in the hydraulic fluid is controlled by operating an electromagnetic valve that is provided to a channel for the hydraulic fluid.

Here, in order to cause the electromagnetic valve, which opens/closes the channel, to function appropriately, a stroke amount of an armature as a movable section in the electromagnetic valve has to be optimized. Accordingly, in order to optimize the stroke amount of the armature, a technique of estimating the stroke amount of the armature has been proposed (for example, see JP2019172015A).

However, it is unclear whether the stroke amount of the armature of the electromagnetic valve can accurately be estimated by the conventional technique related to the hydraulic pressure control unit. In other words, a new proposal for a mechanism that estimates the stroke amount of the armature is desired.

### SUMMARY

The present invention has been made in view of the above-described problem as the background and therefore obtains a hydraulic pressure control unit capable of accurately estimating a stroke amount of an armature of an electromagnetic valve.

A hydraulic pressure control unit according to the present invention is a hydraulic pressure control unit used for a behavior control system of a vehicle, and includes: a hydraulic pressure control mechanism that includes a base body and components that include an electromagnetic valve assembled in the base body for controlling a hydraulic pressure generated in a hydraulic fluid for the behavior control system; and a controller that includes a control section controlling operation of the components. The electromagnetic valve includes a wire and an armature that moves in association with application of a current to the wire, and is a valve that is closed or a valve that is opened in an energized state where the current is applied to the wire. The controller includes an estimation section that estimates a stroke amount of the armature. The estimation section estimates the stroke amount on the basis of a reduced amount of a current value at a time when the current value is temporarily reduced in a process that the current value of the current flowing through the wire is increased toward a target current value at beginning of the application of the current to the wire.

In the hydraulic pressure control unit according to the present invention, the controller includes the estimation section that estimates the stroke amount of the armature of the electromagnetic valve. The estimation section estimates the stroke amount on the basis of the reduced amount of the current value at the time when the current value is temporarily reduced in the process that the current value of the current flowing through the wire is increased toward the target current value at beginning of application of the current to the wire of the electromagnetic valve. In this way, it is possible to appropriately estimate the stroke amount of the armature by focusing on a phenomenon that a counter-electromotive force is generated to the wire in association with movement of the armature. Therefore, it is possible to accurately estimate the stroke amount of the armature of the electromagnetic valve.

### BRIEF DESCRIPTION OF DRAWINGS

FIG. 1 is a schematic view illustrating an outline configuration of a vehicle according to an embodiment of the present invention.

FIG. 2 is a schematic view illustrating an outline configuration of a brake system according to the embodiment of the present invention.

FIG. 3 is a schematic cross-sectional view illustrating an example of an electromagnetic valve in a hydraulic pressure control unit according to the embodiment of the present invention.

FIG. 4 is a schematic diagram illustrating an example of a current sensor in the hydraulic pressure control unit according to the embodiment of the present invention.

FIG. 5 is a block diagram illustrating an example of a functional configuration of a controller according to the embodiment of the present invention.

FIG. 6 is a schematic graph illustrating an example of transition of a current value of a current flowing through a wire at beginning of application of the current to the wire of the electromagnetic valve in the hydraulic pressure control unit according to the embodiment of the present invention.

FIG. 7 is a flowchart illustrating an example of a processing procedure that is related to estimation of a stroke amount of an armature that is executed by the controller according to the embodiment of the present invention.

### DETAILED DESCRIPTION

A description will hereinafter be made on a hydraulic pressure control unit according to the present invention with reference to the drawings.

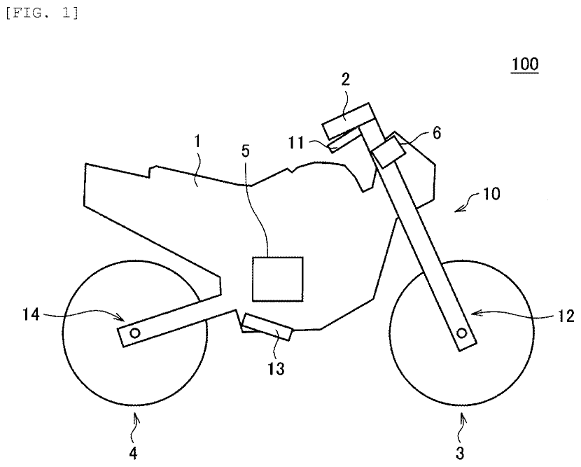

A description will hereinafter be made on the hydraulic pressure control unit that is used for a brake system of a two-wheeled motorcycle (see a vehicle 100 in FIG. 1). However, the hydraulic pressure control unit according to the present invention may be used for a behavior control system other than the brake system (for example, a system that controls a damping force of a suspension, or the like). In addition, the hydraulic pressure control unit according to the present invention may be used for the behavior control system of a vehicle other than the two-wheeled motorcycle (for example, another straddle-type vehicle, such as an all-terrain vehicle, a three-wheeled motorcycle, or a bicycle, a four-wheeled automobile, or the like). Here, the straddle-type vehicle means a vehicle that a rider straddles, and includes a scooter and the like.

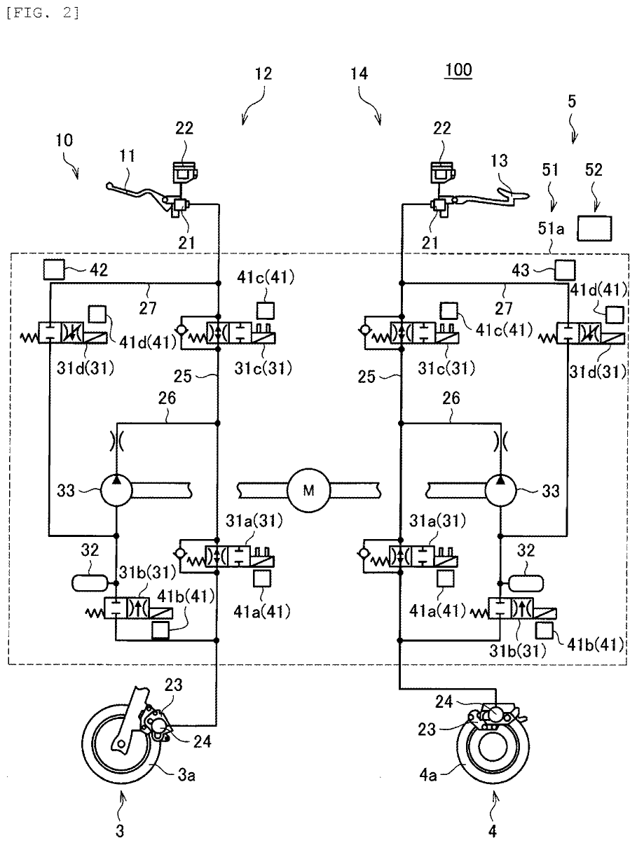

A description will hereinafter be made on a case where one front-wheel brake mechanism and one rear-wheel brake mechanism are provided (see a front-wheel brake mechanism 12 and a rear-wheel brake mechanism 14 in FIG. 2). However, at least one of the front-wheel brake mechanism and the rear-wheel brake mechanism may be plural. Alternatively, one of the front-wheel brake mechanism and the rear-wheel brake mechanism may not be provided.

A configuration, operation, and the like, which will be described below, constitute merely one example, and the hydraulic pressure control unit according to the present invention is not limited to a case with such a configuration, such operation, and the like.

The same or similar description will appropriately be simplified or will not be made below. In the drawings, the same or similar members or portions will not be denoted by a reference sign or will be denoted by the same reference sign. A detailed structure will appropriately be illustrated in a simplified manner or will not be illustrated.

### <Vehicle Configuration>

A description will be made on a configuration of the vehicle 100 according to an embodiment of the present invention with reference to FIG. 1 to FIG. 5.

FIG. 1 is a schematic view illustrating an outline configuration of the vehicle 100. FIG. 2 is a schematic view illustrating an outline configuration of a brake system 10.

The vehicle 100 is a two-wheeled motorcycle that corresponds to an example of the vehicle according to the present invention. As illustrated in FIG. 1, the vehicle 100 includes: a trunk 1; a handlebar 2 that is held by the trunk 1 in a freely turnable manner; a front wheel 3 that is held by the trunk 1 in the freely turnable manner with the handlebar 2; a rear wheel 4 that is held by the trunk 1 in a freely rotatable manner; a hydraulic pressure control unit 5; and a notification device 6. The hydraulic pressure control unit 5 is used for the brake system 10 of the vehicle 100. The notification device 6 notifies the rider. The notification device 6 has a sound output function and a display function. The sound output function is a function to output sound and is implemented by a speaker, for example. The display function is a function to show information visually, and is implemented by a liquid-crystal display, a lamp, or the like, for example. The vehicle 100 includes a drive source such as an engine or a motor, and travels by using power that is output from the drive source.

As illustrated in FIG. 1 and FIG. 2, the brake system 10 includes: a first brake operation section 11; the front-wheel brake mechanism 12 that brakes the front wheel 3 in an interlocking manner with at least the first brake operation section 11; a second brake operation section 13; and the rear-wheel brake mechanism 14 that brakes the rear wheel 4 in an interlocking manner with at least the second brake operation section 13. The brake system 10 also includes the hydraulic pressure control unit 5, and the front-wheel brake mechanism 12 and the rear-wheel brake mechanism 14 are partially included in the hydraulic pressure control unit 5. The hydraulic pressure control unit 5 is a unit that has a function of controlling a braking force to be applied to the front wheel 3 by the front-wheel brake mechanism 12 and a braking force to be applied to the rear wheel 4 by the rear-wheel brake mechanism 14.

The first brake operation section 11 is provided to the handlebar 2 and is operated by the rider's hand. The first brake operation section 11 is a brake lever, for example. The second brake operation section 13 is provided to a lower portion of the trunk 1 and is operated by the rider's foot. The second brake operation section 13 is a brake pedal, for example. However, like a brake operation section of a scooter or the like, each of the first brake operation section 11 and the second brake operation section 13 may be a brake lever that is operated by the rider's hand.

Each of the front-wheel brake mechanism 12 and the rear-wheel brake mechanism 14 includes: a master cylinder 21 in which a piston (not illustrated) is installed; a reservoir 22 that is attached to the master cylinder 21; a brake caliper 23 that is held by the trunk 1 and has a brake pad (not illustrated); a wheel cylinder 24 that is provided to the brake caliper 23; a primary channel 25 through which a brake fluid in the master cylinder 21 flows into the wheel cylinder 24; a secondary channel 26 through which the brake fluid in the wheel cylinder 24 is released; and a supply channel 27 through which the brake fluid in the master cylinder 21 is supplied to the secondary channel 26.

Each of the front-wheel brake mechanism 12 and the rear-wheel brake mechanism 14 is provided with an electromagnetic valve 31 for controlling a hydraulic pressure generated in the brake fluid as a hydraulic fluid. In an example illustrated in FIG. 2, the electromagnetic valves 31 are an inlet valve (EV) 31a, an outlet valve (AV) 31b, a first valve (USV) 31c, and a second valve (HSV) 31d.

The inlet valve 31a is provided to the primary channel 25. The secondary channel 26 bypasses a portion of the primary channel 25 between the wheel cylinder 24 side and the master cylinder 21 side of the inlet valve 31a. The secondary channel 26 is sequentially provided with the outlet valve 31b, an accumulator 32, and a pump 33 from an upstream side. The first valve 31c is provided between an end on the master cylinder 21 side of the primary channel 25 and a portion of the primary channel 25 to which a downstream end of the secondary channel 26 is connected. The supply channel 27 communicates between the master cylinder 21 and a portion of the secondary channel 26 on a suction side of the pump 33. The second valve 31d is provided to the supply channel 27.

The inlet valve 31a is the electromagnetic valve 31 that is opened in an unenergized state and is closed in an energized state, for example. The outlet valve 31b is the electromagnetic valve 31 that is closed in the unenergized state and opened in the energized state, for example. The first valve 31c is the electromagnetic valve 31 that is opened in the unenergized state and is closed in the energized state, for example. The second valve 31d is the electromagnetic valve 31 that is closed in the unenergized state and is opened in the energized state, for example.

The hydraulic pressure control unit 5 includes: a hydraulic pressure control mechanism 51 that includes a part of the front-wheel brake mechanism 12 and a part of the rear-wheel brake mechanism 14 described above; and a controller (ECU) 52 that controls operation of the hydraulic pressure control mechanism 51.

The hydraulic pressure control mechanism 51 includes: a base body 51a; and components that are assembled in the base body 51a and include the electromagnetic valves 31 for controlling the hydraulic pressure generated in the brake fluid as the hydraulic fluid in the brake system 10. The component means an element such as a part that is assembled in the base body 51a.

The base body 51a has a substantially rectangular-parallelepiped shape and is formed of a metal material, for example. In the base body 51a of the hydraulic pressure control mechanism 51, the primary channels 25, the secondary channels 26, and the supply channels 27 are formed, and the electromagnetic valves 31 (more specifically, the inlet valves 31a, the outlet valves 31b, the first valves 31c, and the second valves 31d), the accumulators 32, and the pumps 33 are assembled as the components therein. As will be described below, operation of each of these components is controlled by the controller 52 of the hydraulic pressure control unit 5. The base body 51a may be formed of one member or may be formed of plural members. In the case where the base body 51a is formed of plural members, the components may separately be provided in the plural members.

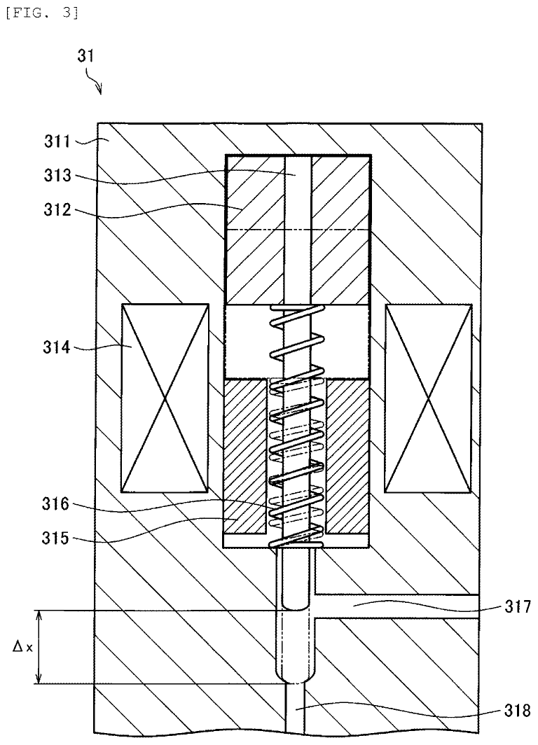

A description will hereinafter be made on a detailed configuration of the electromagnetic valve 31 that is provided to the hydraulic pressure control unit 5 with reference to FIG. 3. FIG. 3 is a schematic cross-sectional view illustrating an example of the electromagnetic valve 31 in the hydraulic pressure control unit 5. Hereinafter, a description will primarily be made on a case where the electromagnetic valve 31 in FIG. 3 is a valve that is closed in the energized state (more specifically, the inlet valve 31a and the first valve 31c). Then, a description on a valve that is opened in the energized state (more specifically, the outlet valve 31b and the second valve 31d) will be supplemented.

As illustrated in FIG. 3, the electromagnetic valve 31 includes a case 311, an armature 312, a tappet 313, a wire 314, a core 315, a spring 316, a first channel 317, and a second channel 318, for example.

The armature 312 corresponds to a movable section that can reciprocate relative to the case 311 in the case 311. The armature 312 has a substantially cylindrical shape, for example. The armature 312 is arranged in an internal space that is formed in the case 311, and can reciprocate along an axial direction of the armature 312. The tappet 313 is fixed to the armature 312 and can move integrally with the armature 312. For example, the tappet 313 is a solid rod member that has a circular cross-sectional shape, and is fitted and fixed to an inner circumferential section of the armature 312.

The wire 314 is fixed to the case 311, and generates a magnetic field when being applied with a current. For example, the wire 314 is provided in a manner to surround the internal space of the case 311 along a circumferential direction of the armature 312. The core 315 is an iron core that is magnetized by the magnetic field generated by the wire 314, and has a substantially cylindrical shape, for example. In the internal space of the case 311, the core 315 is coaxially arranged with the armature 312, and the tappet 313 is inserted through an inner circumferential section of the core 315. When the core 315 is magnetized, a magnetic force in a direction to approach the core 315 acts on the armature 312. In this way, the armature 312 moves in association with application of the current to the wire 314.

The spring 316 urges the armature 312 in a direction away from the core 315. For example, in the internal space of the case 311, the spring 316 is provided in a manner to be held between an inner circumferential section of the case 311 and an end surface of the armature 312 on the core 315 side.

The first channel 317 and the second channel 318 are formed in the case 311 and each form a part of the primary channel 25, the secondary channel 26, or the supply channel 27 provided with the electromagnetic valve 31. In addition, in the case 311, the first channel 317 and the second channel 318 are mutually connected via a space where a tip of the tappet 313 is accommodated.

In the electromagnetic valve 31 (more specifically, the inlet valve 31a and the first valve 31c) that is closed in the energized state, in a state where the current is not applied to the wire 314 (that is, the unenergized state), as indicated by a solid line in FIG. 3, the armature 312 is held at a position away from the core 315 by an urging force of the spring 316. In this way, the first channel 317 and the second channel 318 are brought into a mutually communicating state (that is, a state where the electromagnetic valve 31 is opened).

Meanwhile, in a state where the current is applied to the wire 314 (that is, in the energized state), the armature 312 is attracted to the core 315 side with the tappet 313 by the magnetic force generated between the magnetized core 315 and the armature 312, and is held at a position indicated by a two-dot chain line in FIG. 3. In this way, an opening at an end of the second channel 318 is closed by the tip of the tappet 313. As a result, the first channel 317 and the second channel 318 are brought into a mutually blocked state (that is, a state where the electromagnetic valve 31 is closed).

In the electromagnetic valve 31 that is opened in the energized state (more specifically, the outlet valve 31b and the second valve 31d), in the unenergized state, as indicated by the two-dot chain line in FIG. 3, the opening at the end of the second channel 318 is closed by the tip of the tappet 313, and the first channel 317 and the second channel 318 are brought into the mutually blocked state (that is, the state where the electromagnetic valve 31 is closed). Then, in the energized state, the magnetic force in a direction away from the opening at the end of the second channel 318 acts on the armature 312, and, as indicated by the solid line in FIG. 3, the first channel 317 and the second channel 318 are brought into the mutually communicating state (that is, the state where the electromagnetic valve 31 is opened).

As illustrated in FIG. 2, the hydraulic pressure control unit 5 is provided with a current sensor 41 that detects a current value of the current flowing through the wire 314 of the electromagnetic valve 31. Here, the current sensor 41 may detect another physical quantity that can substantially be converted to the current value of the current flowing through the wire 314 of the electromagnetic valve 31. The current sensor 41 is provided for each of the electromagnetic valves 31. More specifically, the current sensor 41 includes: a current sensor 41a that is provided for the inlet valve 31a; a current sensor 41b that is provided for the outlet valve 31b, a current sensor 41c that is provided for the first valve 31c; and a current sensor 41d that is provided for the second valve 31d. A detection result of each of the current sensors 41 is output to the controller 52 and is used for processing executed by the controller 52.

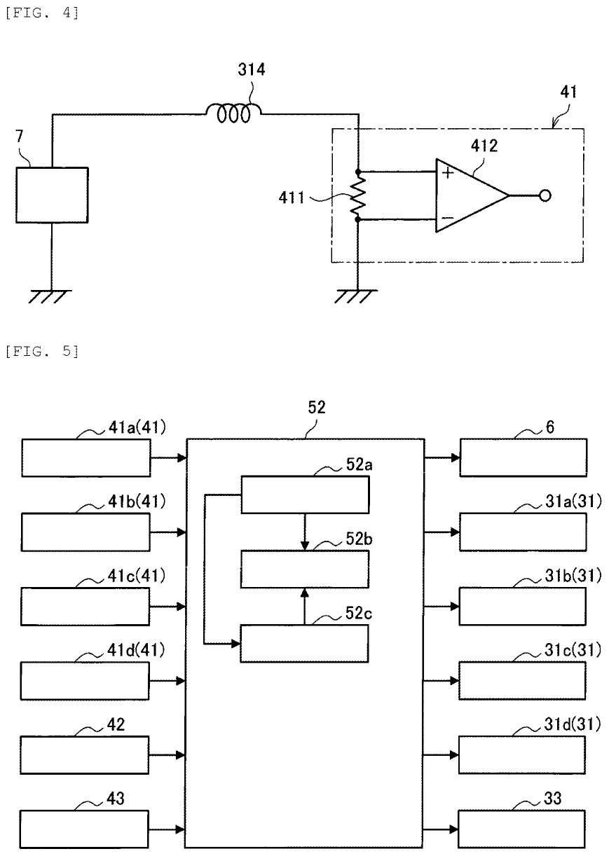

A description will hereinafter be made on a detailed configuration of the current sensor 41 that is provided to the hydraulic pressure control unit 5 with reference to FIG. 4. FIG. 4 is a schematic diagram illustrating an example of the current sensor 41 in the hydraulic pressure control unit 5.

As illustrated in FIG. 4, the current sensor 41 includes a shunt resistor 411 and an operational amplifier 412, for example.

The shunt resistor 411 is connected in series to the wire 314 of the electromagnetic valve 31 that is connected to a power supply 7 such as a secondary battery. Electric power is supplied from the power supply 7 to the wire 314 of the electromagnetic valve 31. The operational amplifier 412 is connected in parallel with the shunt resistor 411 and amplifies a difference in voltage generated at both ends of the shunt resistor 411 to output. The current sensor 41 detects the current value of the current flowing through the wire 314 of the electromagnetic valve 31 on the basis of a resistance value of the shunt resistor 411 and an output value of the operational amplifier 412.

As illustrated in FIG. 2, the hydraulic pressure control unit 5 is provided with temperature sensors 42, 43, each of which detects a temperature of the brake fluid. Each of the temperature sensors 42, 43 may detect another physical quantity that can substantially be converted to the temperature of the brake fluid. The temperature sensor 42 is provided to the front-wheel brake mechanism 12 and detects the temperature of the brake fluid in the front-wheel brake mechanism 12. The temperature sensor 43 is provided to the rear-wheel brake mechanism 14 and detects the temperature of the brake fluid in the rear-wheel brake mechanism 14. Each of the temperature sensors 42, 43 is provided in a master cylinder pressure sensor, for example.

The controller 52 in the hydraulic pressure control unit 5 controls the operation of the above-described components that are assembled in the base body 51a of the hydraulic pressure control mechanism 51. For example, the controller 52 is partially or entirely constructed of a microcomputer, a microprocessor unit, or the like. In addition, the controller 52 may partially or entirely be constructed of one whose firmware and the like can be updated, or may partially or entirely be a program module or the like that is executed by a command from a CPU or the like, for example. The controller 52 may be provided as one unit or may be divided into plural units, for example. Furthermore, the controller 52 may be attached to the base body 51a or may be attached to a member other than the base body 51a.

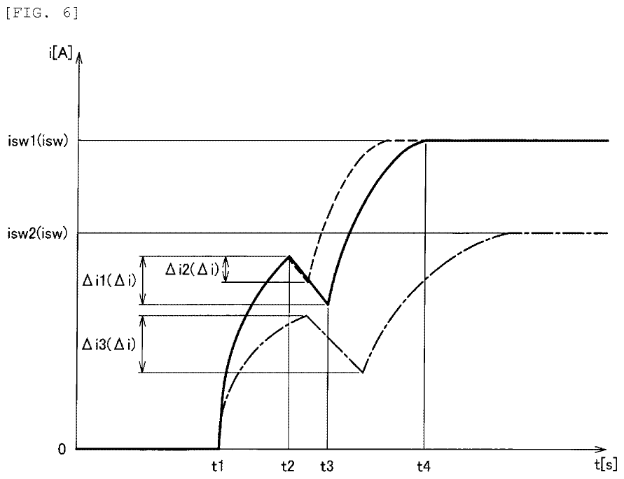

FIG. 5 is a block diagram illustrating an example of a functional configuration of the controller 52 in the hydraulic pressure control unit 5. As illustrated in FIG. 5, the controller 52 includes an acquisition section 52a, a control section 52b, and an estimation section 52c, for example.

The acquisition section 52a acquires information from each of the sensors provided in the hydraulic pressure control unit 5 and outputs the information to the control section 52b and the estimation section 52c. For example, the acquisition section 52a acquires information from each of the current sensors 41 and the temperature sensors 42, 43.

The control section 52b controls the operation of each of the above-described components that are assembled in the base body 51a of the hydraulic pressure control mechanism 51. In this way, the control section 52b can control the braking force to be applied to the front wheel 3 by the front-wheel brake mechanism 12 and the braking force to be applied to the rear wheel 4 by the rear-wheel brake mechanism 14. As will be described below, the control section 52b can also control operation of the notification device 6.

The control section 52b controls the operation of each of the above components according to a travel state of the vehicle 100, for example. In a normal time (that is, when anti-lock brake control, automated brake control, or the like, which will be described below, is not executed), the control section 52b opens the inlet valve 31a and closes the outlet valve 31b. When the first brake operation section 11 is operated in such a state, in the front-wheel brake mechanism 12, the piston (not illustrated) in the master cylinder 21 is pressed to increase a hydraulic pressure of the brake fluid in the wheel cylinder 24, the brake pad (not illustrated) of the brake caliper 23 is then pressed against a rotor 3a of the front wheel 3, and the braking force is thereby generated on the front wheel 3. Meanwhile, when the second brake operation section 13 is operated, in the rear-wheel brake mechanism 14, the piston (not illustrated) in the master cylinder 21 is pressed to increase the hydraulic pressure of the brake fluid in the wheel cylinder 24, the brake pad (not illustrated) of the brake caliper 23 is then pressed against a rotor 4a of the rear wheel 4, and the braking force is thereby generated on the rear wheel 4.

The anti-lock brake control is control that is executed when the wheel (more specifically, the front wheel 3 or the rear wheel 4) is locked or possibly locked and that reduces the braking force applied to the wheel without relying on a brake operation by the rider, for example. For example, in a state where the anti-lock brake control is executed, the control section 52b closes the inlet valve 31a, opens the outlet valve 31b, opens the first valve 31c, and closes the second valve 31d. When the pump 33 is driven by the control section 52b in such a state, the hydraulic pressure of the brake fluid in the wheel cylinder 24 is reduced, and the braking force that is applied to the wheel is thereby reduced.

The automated brake control is control that is executed when it is necessary to stabilize a posture of the vehicle 100 during turning or the like of the vehicle 100 and that causes generation of the braking force to be applied to the wheel (more specifically, the front wheel 3 or the rear wheel 4) without relying on the brake operation by the rider, for example. For example, when the automated brake control is executed, the control section 52b opens the inlet valve 31a, closes the outlet valve 31b, closes the first valve 31c, and opens the second valve 31d. When the pump 33 is driven by the control section 52b in such a state, the hydraulic pressure of the brake fluid in the wheel cylinder 24 is increased, and the braking force that brakes the wheel is thereby generated.

The estimation section 52c estimates a stroke amount Δx (see FIG. 3) of the armature 312 of the electromagnetic valve 31. The stroke amount Δx of the armature 312 is a distance from a movement start position to a movement end position of the armature 312 (that is, an movement amount of the armature 312) when the current is applied to the wire 314 of the electromagnetic valve 31. As described above, since the tappet 313 can move integrally with the armature 312, the stroke amount Δx of the armature 312 matches a stroke amount of the tappet 313.

In the example illustrated in FIG. 3, when the current is applied to the wire 314, as indicated by the two-dot chain line, the armature 312 moves to a position at which the electromagnetic valve 31 is brought into the closed state. That is, the stroke amount Δx of the armature 312 is sufficiently large to allow the electromagnetic valve 31 to function appropriately. Here, for example, in the case where viscosity of the brake fluid is increased in association with a temperature decrease, or the like, the stroke amount Δx of the armature 312 is reduced, which possibly hinders the brake fluid from being blocked or distributed by the electromagnetic valve 31 as assumed. In order to optimize the stroke amount Δx of the armature 312 in such a case, it is necessary to estimate the stroke amount Δx. In the case where the viscosity of the brake fluid is increased, a moving speed of the armature 312 is reduced. This can also be a factor that inhibits the brake fluid from being blocked or distributed by the electromagnetic valve 31 as assumed.

In this embodiment, by devising the processing for estimating the stroke amount Δx of the armature 312 that is executed by the controller 52, the stroke amount Δx is accurately estimated. A detailed description on such processing for estimating the stroke amount Δx of the armature 312 will be made below.

### <Operation of Hydraulic Pressure Control Unit>

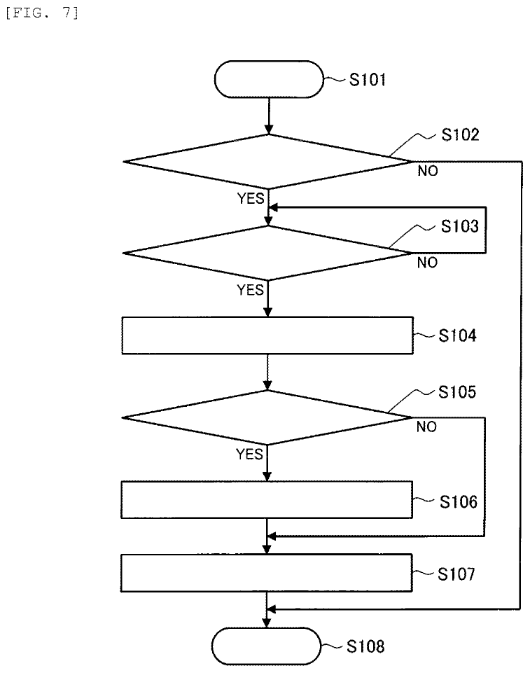

A description will herein be made on operation of the hydraulic pressure control unit 5 according to the embodiment of the present invention with reference to FIG. 6 and FIG. 7.

In this embodiment, the estimation section 52c estimates the stroke amount Δx of the armature 312 on the basis of behavior of the current value of the current flowing through the wire 314 at beginning of the application of the current to the wire 314 of the electromagnetic valve 31. A description will hereinafter be made on the behavior of the current value of the current flowing through the wire 314 at beginning of the application of the current to the wire 314 with reference to FIG. 6.

FIG. 6 is a schematic graph illustrating an example of transition of the current value of the current flowing through the wire 314 at the beginning of the application of the current to the wire 314 of the electromagnetic valve 31 in the hydraulic pressure control unit 5. In FIG. 6, a horizontal axis represents time t [s], and a vertical axis represents a current value i [A] of the current flowing through the wire 314.

When the current starts being applied to the wire 314 of the electromagnetic valve 31, the current value i of the current flowing through the wire 314 starts being increased toward a target current value isw. Then, after reaching the target current value isw, the current value i is maintained at the target current value isw. In the present specification, time at which the current starts being applied to the wire 314 of the electromagnetic valve 31 means a period from time at which the current value i starts being increased in association with the application of the current to the wire 314 to time at which the current value i reaches the target current value isw.

In the example indicated by a solid line in FIG. 6, at a time point t1, the current starts being applied to the wire 314, and the current value i of the current flowing through the wire 314 starts being increased. Thereafter, at a time point t4, the current value i reaches a target current value isw1. Then, at the time point t4 onward, the current value i is maintained at the target current value isw1. The target current value isw in the example indicated by the solid line in FIG. 6 is the target current value isw1. However, the control section 52b can vary the target current value isw.

Here, when the current starts being applied to the wire 314, the core 315 is magnetized, and the magnetic force in the direction to approach the core 315 acts on the armature 312. Consequently, the armature 312 is attracted to and moves toward the core 315 side with the tappet 313. At this time, in the magnetic field generated by the wire 314, the armature 312 moves relative to the magnetic field. As a result, a counter-electromotive force is generated to the wire 314 in a manner to weaken magnetic flux generated by the wire 314. Thus, in a process in which the current value i of the current flowing through the wire 314 is increased toward the target current value isw, the current value i exhibits behavior of being temporarily reduced. For example, in the example indicated by the solid line in FIG. 6, at a time point t2, the current value i starts being reduced. Thereafter, at a time point t3, the reduction of the current value i is stopped, and the current value i starts being increased again toward the target current value isw.

In this embodiment, the estimation section 52c estimates the stroke amount Δx of the armature 312 on the basis of a reduced amount Δi of the current value i at the time when the current value i is temporarily reduced in the process in which the current value i of the current flowing through the wire 314 is increased toward the target current value isw at the beginning of the application of the current to the wire 314 of the electromagnetic valve 31. For example, the reduced amount Δi in the example indicated by the solid line in FIG. 6 is a reduced amount Δi1 that corresponds to a difference between the current value i at the time point t2 and the current value i at the time point t3. When a phenomenon that the counter-electromotive force is generated to the wire 314 in association with the movement of the armature 312 is focused, it is understood that the reduced amount Δi of the current value i is reduced with the reduction in the stroke amount Δx of the armature 312. Accordingly, the estimation section 52c estimates the stroke amount Δx as the smaller value as the reduced amount Δi is reduced, for example. In this way, it is possible to accurately estimate the stroke amount Δx of the armature 312 by focusing on the phenomenon that the counter-electromotive force is generated to the wire 314 in association with the movement of the armature 312.

Here, in the case where the current value i from a reduction start time point of the current value i (for example, the time point t2 in the example indicated by the solid line in FIG. 6) to a time point after a lapse of a reference time is lower than the current value i at the reduction start time point by a reference value or greater (that is, in the case where a difference between the current value i from the reduction start time point of the current value i to the time point after the lapse of the reference time and the current value i at the reduction start time point is equal to or larger than the reference value), the estimation section 52c determines that the current value i is temporarily reduced. Each of the reference time and the reference value described above is set to a value with which it is possible to distinguish whether the current value i is temporarily reduced due to the generation of the counter-electromotive force to the wire 314 or whether a detection value of the current sensor 41 is only momentarily and slightly reduced by a noise component. In other words, in the case where the difference between the current value i from the reduction start time point of the current value i to the time point after the lapse of the reference time and the current value i at the reduction start time point is smaller than the reference value, the estimation section 52c determines that the detection value of the current sensor 41 is only momentarily and slightly reduced by the noise component, and thus does not estimate the stroke amount Δx.

Compared to the example indicated by the solid line, an example indicated by a broken line in FIG. 6 is an example at the different temperature of the brake fluid. In addition, compared to the example indicated by the solid line, an example indicated by a one-dot chain line in FIG. 6 is an example with the different target current value isw. These examples will be described below.

FIG. 7 is a flowchart illustrating an example of a processing procedure that is related to the estimation of the stroke amount Δx of the armature 312 that is executed by the controller 52 of the hydraulic pressure control unit 5. For example, the control flow illustrated in FIG. 7 is repeatedly initiated at a time interval, which is set in advance, after being terminated. Step S101 and step S108 in FIG. 7 respectively correspond to initiation and termination of the control flow.

The control flow illustrated in FIG. 7 is executed sequentially or in parallel for each of the electromagnetic valves 31, for example. In addition, the control flow illustrated in FIG. 7 is executed sequentially or in parallel for each of the brake mechanisms that are the front-wheel brake mechanism 12 and the rear-wheel brake mechanism 14, for example. However, the control flow illustrated in FIG. 7 may be executed only for some of the electromagnetic valves 31 in the hydraulic pressure control unit 5. In such a case, the current sensor 41 only needs to be provided for the electromagnetic valve 31 whose stroke amount Δx is estimated. The processing related to the estimation of the stroke amount Δx, which will be described below, can be applied to the valves that are closed in the energized state (more specifically, the inlet valve 31a and the first valve 31c), and can also be applied to the valves that are opened in the energized state (more specifically, the outlet valve 31b and the second valve 31d).

When the control flow illustrated in FIG. 7 is initiated, in step S102, the estimation section 52c determines whether the current starts being applied to the wire 314 of the electromagnetic valve 31. If it is determined that the current starts being applied to the wire 314 (step S102/YES), the processing proceeds to step S103. On the other hand, if it is determined that the current does not start being applied to the wire 314 (step S102/NO), the control flow illustrated in FIG. 7 is terminated.

For example, the estimation section 52c determines whether the current starts being applied to the wire 314 on the basis of the detection value of the current sensor 41. As described above, when the current starts being applied to the wire 314, the current value i of the current flowing through the wire 314 starts being increased toward the target current value isw. Accordingly, the estimation section 52c can determine whether the current starts being applied to the wire 314 on the basis of the behavior of the current value i of the current flowing through the wire 314 (for example, whether the current value i is increased to exceed a specified value).

If it is determined YES in step S102, in step S103, the estimation section 52c determines whether the current value i of the current flowing through the wire 314 of the electromagnetic valve 31 stops being increased. If it is determined that the current value i of the current flowing through the wire 314 stops being increased (step S103/YES), the processing proceeds to step S104. On the other hand, if it is determined that the current value i of the current flowing through the wire 314 does not stop being increased (step S103/NO), the determination processing in step S103 is repeated.

For example, the estimation section 52c determines whether the current value i of the current flowing through the wire 314 stops being increased on the basis of the detection value of the current sensor 41. As described above, after being increased to the target current value isw, the current value i of the current flowing through the wire 314 is maintained at the target current value isw. Accordingly, the estimation section 52c can determine whether the current value i of the current flowing through the wire 314 stops being increased on the basis of the behavior of the current value i of the current flowing through the wire 314 (for example, whether a fluctuation width of the current value i becomes equal to or smaller than a specified value).

If it is determined YES in step S103, in step S104, the estimation section 52c estimates the stroke amount Δx of the armature 312. More specifically, as described above, the estimation section 52c estimates the stroke amount Δx of the armature 312 on the basis of the reduced amount Δi of the current value i at the time when the current value i is temporarily reduced in the process in which the current value i of the current flowing through the wire 314 is increased toward the target current value isw at the beginning of the application of the current to the wire 314 of the electromagnetic valve 31. For example, after step S102 and until it is determined YES in step S103, the acquisition section 52a keeps acquiring the current value i at each of the time points, and the estimation section 52c can identify the reduced amount Δi on the basis of history of the obtained current value i.

Here, from a perspective of improving estimation accuracy of the stroke amount Δx of the armature 312, the estimation section 52c preferably estimates the stroke amount Δx on the basis of another parameter in addition to the reduced amount Δi of the current value i.

For example, the estimation section 52c estimates the stroke amount Δx on the basis of viscosity index information that is information as an index of viscosity evaluation of the brake fluid as the hydraulic fluid in addition to the reduced amount Δi of the current value i. The viscosity index information includes temperature information of the brake fluid (that is, information on the temperature of the brake fluid), for example. There is a relationship that the viscosity of the brake fluid is increased with the reduction in the temperature of the brake fluid. Thus, the temperature of the brake fluid is the index for evaluating the viscosity of the brake fluid. The acquisition section 52a can acquire the temperature information of the brake fluid from the temperature sensors 42, 43, for example. Here, the temperature information of the brake fluid may be information that directly indicates the temperature of the brake fluid, or may be information that indicates another physical quantity that can substantially be converted to the temperature of the brake fluid.

Here, compared to the example indicated by the solid line, in the example indicated by the broken line in FIG. 6, the temperature of the brake fluid is low, and the viscosity of the brake fluid is high. As a result, compared to the example indicated by the solid line, in the example indicated by the broken line in FIG. 6, the reduced amount Δi of the current value i small. More specifically, the reduced amount Δi in the example indicated by the broken line in FIG. 6 is a reduced amount Δi2 that is smaller than the reduced amount Δi1.

As described above, there is a tendency that the reduced amount Δi of the current value i is reduced with the reduction in the temperature of the brake fluid. That is, there is a tendency that the reduced amount Δi of the current value i is reduced with an increase in the viscosity of the brake fluid. Just as described, the reduced amount Δi of the current value i varies in association with a change in the viscosity of the brake fluid. Accordingly, the estimation section 52c can improve the estimation accuracy of the stroke amount Δx by estimating the stroke amount Δx (for example, estimating a smaller value as the stroke amount Δx as the temperature of the brake fluid is reduced) by taking not only the reduced amount Δi but also the viscosity index information into consideration.

Although the above description has been made on the example in which the temperature information of the brake fluid is used as the viscosity index information, the estimation section 52c may use the viscosity index information other than the temperature information of the brake fluid. For example, the estimation section 52c may use, as the viscosity index information, the number of days elapsed since a date when the brake fluid is most recently replaced, or information on deceleration that is generated to the vehicle 100 during actuation of the anti-lock brake control, or the like.

Alternatively, for example, the estimation section 52c estimates the stroke amount Δx on the basis of the target current value isw in addition to the reduced amount Δi of the current value i.

Here, compared to the example indicated by the solid line, in the example indicated by the one-dot chain line in FIG. 6, the target current value isw is small. More specifically, the target current value isw in the example indicated by the one-dot chain line in FIG. 6 is the target current value isw2 that is lower than the target current value isw1. As a result, compared to the example indicated by the solid line, in the example indicated by the one-dot chain line in FIG. 6, the reduced amount Δi of the current value i is large. More specifically, the reduced amount Δi in the example indicated by the one-dot chain line in FIG. 6 is a reduced amount Δi3 that is larger than the reduced amount Δi1.

As described above, there is a tendency that the reduced amount Δi of the current value i is increased with the reduction in the target current value isw. Just as described, the reduced amount Δi of the current value i varies in association with a change in the target current value isw. Accordingly, the estimation section 52c can improve the estimation accuracy of the stroke amount Δx by estimating the stroke amount Δx (for example, estimating a larger value as the stroke amount Δx as the target current value isw is reduced) by taking not only the reduced amount Δi but also the target current value isw into consideration.

The above description has sequentially been made on the example in which the viscosity index information of the brake fluid is used in addition to the reduced amount Δi of the current value i for the estimation of the stroke amount Δx and the example in which the target current value isw is used in addition to the reduced amount Δi of the current value i therefor. However, from a perspective of effectively improving the estimation accuracy of the stroke amount Δx of the armature 312, the estimation section 52c preferably estimates the stroke amount Δx on the basis of both of the viscosity index information of the brake fluid and the target current value isw in addition to the reduced amount Δi of the current value i. A mathematical formula, a map, or the like that specifies the relationship between the stroke amount Δx and each of the parameters (for example, the reduced amount Δi, the temperature of the brake fluid, and the target current value isw) and that is used to estimate the stroke amount Δx may be determined on the basis of a theoretical formula or may be determined on the basis of an experimental result.

Next, in step S105, the control section 52b determines whether the stroke amount Δx is smaller than a reference stroke amount. If it is determined that the stroke amount Δx is smaller than the reference stroke amount (step S105/YES), the processing proceeds to step S106, and the control section 52b increases the target current value isw to be higher than the current value. Accordingly, in the process of repeating the control flow illustrated in FIG. 7, the target current value isw is gradually increased until the stroke amount Δx becomes equal to or larger than the reference stroke amount (that is, until it is determined NO in step S105). On the other hand, if it is determined that the stroke amount Δx is equal to or larger than the reference stroke amount (step S105/NO), the processing proceeds to step S107.

The reference stroke amount in step S105 is set to a value with which it is possible to determine whether the stroke amount Δx is large enough to allow the electromagnetic valve 31 to function appropriately. In other words, if it is determined that the stroke amount Δx is equal to or larger than the reference stroke amount (that is, if it is determined NO in step S105), it is possible to determine that the stroke amount Δx is large enough to allow the electromagnetic valve 31 to function appropriately.

On the other hand, if it is determined that the stroke amount Δx is smaller than the reference stroke amount (that is, if it is determined YES in step S105), it is possible to determine that the stroke amount Δx is insufficient to such extent that the electromagnetic valve 31 does not function appropriately. In such a case, the control section 52b increases the target current value isw to be higher than the current value. In this way, the stroke amount Δx can be increased. Thus, it is possible to eliminate shortage of the stroke amount Δx and allow the electromagnetic valve 31 to function appropriately.

As described above, from a perspective of avoiding the shortage of the stroke amount Δx, the control section 52b preferably controls the target current value isw on the basis of an estimation result of the stroke amount Δx. More specifically, in the above example, the control section 52b increases the target current value isw in the case where the current stroke amount Δx is smaller than the reference stroke amount. However, the control section 52b may increase the target current value isw in the case where it is predicted that the stroke amount Δx possibly falls below the reference stroke amount in the future.

For example, the control section 52b can predict whether the stroke amount Δx possibly falls below the reference stroke amount in the future on the basis of a temperature such as the current temperature of the brake fluid or an ambient temperature. For example, in the case where the current temperature of the brake fluid is high to some extent, it is assumed that the temperature of the brake fluid is significantly reduced in the future. Accordingly, even when the current stroke amount Δx is equal to or larger than the reference stroke amount, there is a case where the control section 52b predicts that the stroke amount Δx possibly falls below the reference stroke amount in the future. In such a case, it is possible to avoid the shortage of the stroke amount Δx in advance by increasing the target current value isw in advance.

If it is determined NO in step S105, or in step S107 following step S106, the control section 52b controls the notification operation on the basis of the estimation result of the stroke amount Δx, and then the control flow illustrated in FIG. 7 is terminated.

The notification operation is operation to notify the rider of various types of information. For example, the notification operation is performed by the notification device 6 and may be operation to show the information or operation to output sound. Here, in the case where the notification operation continues for a set time, the control flow illustrated in FIG. 7 may be terminated. Alternatively, in the case where the rider performs an input operation to stop the notification operation, the control flow illustrated in FIG. 7 may be terminated.

In step S107, for example, if it is determined that the stroke amount Δx is smaller than the reference stroke amount (that is, if it is determined YES in step S105), the control section 52b causes the notification device 6 to perform the notification operation that notifies of the shortage of the stroke amount Δx to such extent that the electromagnetic valve 31 no longer functions appropriately. On the other hand, if it is determined that the stroke amount Δx is equal to or larger than the reference stroke amount (that is, if it is determined NO in step S105), the control section 52b stops the notification operation by the notification device 6. However, if it is determined NO in step S105, the control section 52b may cause the notification device 6 to perform the notification operation so as to notify that the stroke amount Δx is large enough to allow the electromagnetic valve 31 to function appropriately.

The notification operation may be performed by a device other than the notification device 6. For example, the notification operation may be performed by a display device (for example, a transmissive display arranged over the rider's line of sight) that is provided to a helmet worn on the rider's head. Alternatively, for example, the notification operation may be performed by a sound output device that is provided to the helmet worn on the rider's head. Further alternatively, for example, the notification operation may be operation to generate vibration by a vibration generator that is provided to the vehicle 100 or is attached to the rider. For example, the notification operation may be operation to instantaneously decelerate the vehicle 100. The instantaneous deceleration may occur by reducing output of the drive source, may occur by generating the braking force by the hydraulic pressure control unit 5, or may occur by changing a gear ratio of a transmission mechanism of the vehicle 100.

The above description has been made on the example of the processing procedure related to the estimation of the stroke amount Δx with reference to FIG. 7. However, the processing procedure related to the estimation of the stroke amount Δx is not limited to the example of the flowchart in FIG. 7. For example, an additional step may be added to the flowchart in FIG. 7. For example, some of the steps (for example, step S107 and the like) in the flowchart of FIG. 7 may be omitted. For example, an order of some of the steps in the flowchart of FIG. 7 may be changed (for example, step S107 may be executed prior to step S105).

### <Effects of Hydraulic Pressure Control Unit>

A description will be made on effects of the hydraulic pressure control unit 5 according to the embodiment of the present invention.

In the hydraulic pressure control unit 5, the estimation section 52c estimates the stroke amount Δx of the armature 312 on the basis of the reduced amount Δi of the current value i at the time when the current value i is temporarily reduced in the process in which the current value i of the current flowing through the wire 314 is increased toward the target current value isw at the beginning of the application of the current to the wire 314 of the electromagnetic valve 31. In this way, it is possible to appropriately estimate the stroke amount Δx of the armature 312 by focusing on the phenomenon that the counter-electromotive force is generated to the wire 314 in association with the movement of the armature 312. Thus, it is possible to accurately estimate the stroke amount Δx of the armature 312 of the electromagnetic valve 31. Furthermore, it is also possible to estimate the stroke amount Δx without using a sensor that directly detects the stroke amount Δx of the armature 312.

Preferably, in the hydraulic pressure control unit 5, the estimation section 52c estimates the stroke amount Δx on the basis of the target current value isw in addition to the reduced amount Δi of the current value i. In this way, it is possible to appropriately estimate the stroke amount Δx of the armature 312 by focusing on the relationship between the target current value isw and the reduced amount Δi. Thus, it is possible to improve the estimation accuracy of the stroke amount Δx of the armature 312 of the electromagnetic valve 31.

Preferably, in the hydraulic pressure control unit 5, the estimation section 52c estimates the stroke amount Δx on the basis of the viscosity index information that is the information as the index of the viscosity evaluation of the hydraulic fluid (in the above example, the brake fluid) in addition to the reduced amount Δi of the current value i. In this way, it is possible to further appropriately estimate the stroke amount Δx of the armature 312 by focusing on the relationship between the viscosity of the brake fluid and the reduced amount Δi. Thus, it is possible to improve the estimation accuracy of the stroke amount Δx of the armature 312 of the electromagnetic valve 31.

Preferably, in the hydraulic pressure control unit 5, the viscosity index information includes the temperature information of the hydraulic fluid (in the above example, the brake fluid). In this way, it is possible to appropriately estimate the stroke amount Δx of the armature 312 by focusing on the relationship between the viscosity of the brake fluid and the reduced amount Δi. Thus, it is possible to appropriately improve the estimation accuracy of the stroke amount Δx of the armature 312 of the electromagnetic valve 31.

Preferably, in the hydraulic pressure control unit 5, the control section 52b controls the target current value isw on the basis of the estimation result of the stroke amount Δx. In this way, in the case where the stroke amount Δx is insufficient or possibly becomes insufficient in the future to such extent that the electromagnetic valve 31 no longer functions appropriately, it is possible to avoid the shortage of the stroke amount Δx and cause the electromagnetic valve 31 to function appropriately.

Preferably, in the hydraulic pressure control unit 5, the control section 52b increases the target current value isw in the case where the stroke amount Δx is smaller than the reference stroke amount. In this way, in the case where the stroke amount Δx is insufficient to such extent that the electromagnetic valve 31 no longer functions appropriately, it is possible to eliminate the shortage of the stroke amount Δx and cause the electromagnetic valve 31 to function appropriately.

Preferably, in the hydraulic pressure control unit 5, the control section 52b increases the target current value isw in the case where it is predicted that the stroke amount Δx possibly falls below the reference stroke amount in the future. In this way, in the case where the stroke amount Δx possibly becomes insufficient in the future to such extent that the electromagnetic valve 31 no longer functions appropriately, it is possible to avoid the shortage of the stroke amount Δx in advance and cause the electromagnetic valve 31 to function appropriately.

Preferably, in the hydraulic pressure control unit 5, the control section 52b controls the notification operation on the basis of the estimation result of the stroke amount Δx. In this way, it is possible to notify the rider of the information on the estimation result of the stroke amount Δx. Thus, the rider can understand whether the electromagnetic valve 31 is in the appropriately functioning state. Therefore, safety is improved.

Preferably, in the hydraulic pressure control unit 5, the estimation section 52c determines that the current value i is temporarily reduced in the case where the current value i at the time point after the lapse of the reference time from the reduction start time point of the current value i is lower than the current value i at the reduction start time point by the reference value or greater. In this way, it is possible to distinguish whether the current value i is temporarily reduced due to the generation of the counter-electromotive force to the wire 314 or the detection value of the current sensor 41 is only instantaneously and slightly reduced by the noise component. Thus, it is possible to appropriately estimate the stroke amount Δx by focusing on the phenomenon that the counter-electromotive force is generated to the wire 314 in association with the movement of the armature 312.

The present invention is not limited to the embodiment that has been described. For example, only a part of the embodiment may be implemented.

### REFERENCE SIGNS LIST

1: Trunk
2: Handlebar
3: Front wheel
3a: Rotor
4: Rear wheel
4a: Rotor
5: Hydraulic pressure control unit
6: Notification device
7: Power supply
10: Brake system
11: First brake operation section
12: Front-wheel brake mechanism
13: Second brake operation section
14: Rear-wheel brake mechanism
21: Master cylinder
22: Reservoir
23: Brake caliper
24: Wheel cylinder
25: Primary channel
26: Secondary channel
27: Supply channel
31: Electromagnetic valve
31a: Inlet valve
31b: Outlet valve
31c: First valve
31d: Second valve
32: Accumulator
33: Pump
41: Current sensor
41a: Current sensor
41b: Current sensor
41c: Current sensor
41d: Current sensor
42: Temperature sensor
43: Temperature sensor
51: Hydraulic pressure control mechanism
51a: Base body
52: Controller
52a: Acquisition section
52b: Control section
52c: Estimation section
100: Vehicle
311: Case
312: Armature
313: Tappet
314: Wire
315: Core
316: Spring
317: First channel
318: Second channel
411: Shunt resistor
412: Operational amplifier
i: Current value
isw: Target current value
isw1: Target current value
isw2: Target current value
Δi: Reduced amount
Δi1: Reduced amount
Δi2: Reduced amount
Δi3: Reduced amount
Δx: Stroke amount

1. A hydraulic pressure control unit (5) used for a behavior control system (10) of a vehicle (100), the hydraulic pressure control unit comprising:
a hydraulic pressure control mechanism (51) that includes: a base body (51a); and components that include an electromagnetic valve (31) assembled in the base body (51a) for controlling a hydraulic pressure generated in a hydraulic fluid for the behavior control system (10); and
a controller (52) that includes a control section (52b) controlling operation of the components; wherein
the electromagnetic valve (31) includes a wire (314) and an armature (312) that moves in association with application of a current to the wire (314), and is a valve that is closed or a valve that is opened in an energized state where the current is applied to the wire (314), the controller (52) includes an estimation section (52c) that estimates a stroke amount (Δx) of the armature (312), and
the estimation section (52c) estimates the stroke amount (Δx) on the basis of a reduced amount (Δi) of a current value (i) at a time when the current value (i) is temporarily reduced in a process that the current value (i) of the current flowing through the wire (314) is increased toward a target current value (isw) at beginning of the application of the current to the wire (314).

2. The hydraulic pressure control unit according to claim 1, wherein
the estimation section (52c) estimates the stroke amount (Δx) on the basis of the target current value (isw) in addition to the reduced amount (Δi).

3. The hydraulic pressure control unit according to claim 1,
wherein
the estimation section (52c) estimates the stroke amount (Δx) on the basis of viscosity index information that is information as an index of viscosity evaluation of the hydraulic fluid in addition to the reduced amount (Δi).

4. The hydraulic pressure control unit according to claim 3, wherein
the viscosity index information includes temperature information of the hydraulic fluid.

5. The hydraulic pressure control unit according to claim 1,
wherein
the control section (52b) controls the target current value (isw) on the basis of an estimation result of the stroke amount (Δx).

6. The hydraulic pressure control unit according to claim 5, wherein
the control section (52b) increases the target current value (isw) in the case where the stroke amount (Δx) is smaller than a reference stroke amount.

7. The hydraulic pressure control unit according to claim 5,
wherein
the control section (52b) increases the target current value (isw) in the case where it is predicted that the stroke amount (Δx) possibly falls below a reference stroke amount in the future.

8. The hydraulic pressure control unit according to claim 1,
wherein
the control section (52b) controls notification operation on the basis of an estimation result of the stroke amount (Δx).

9. The hydraulic pressure control unit according to claim 1,
wherein
the estimation section (52c) determines that the current value (i) is temporarily reduced in the case where the current value (i) at a time point after a lapse of a reference time from a reduction start time point of the current value (i) is lower than the current value (i) at the reduction start time point by a reference value or greater.

10. The hydraulic pressure control unit according to claim 1,
wherein
the vehicle (100) is a motorcycle.
